(19) United States
(12) Patent Application Publication
(10) Pub. No.: US 2004/0025136 A1
(43) Pub. Date: Feb. 5, 2004

(54) Method for designing a custom ASIC library

(76) Inventor: John A. Carelli JR., Allentown, PA (US)

Correspondence Address: Naren Chaganti, 345 Sheridan Avenue, #308, Palo Alto, CA, 94306, US

(21) Appl. No.: 10/208,611

(22) Filed: Jul. 30, 2002

(51) Int. Cl. G06F 17/50

(52) U.S. Cl. 716/17

(57) ABSTRACT

In an aspect, this disclosure is directed toward a method of generating a technology library at a non-standard T/V point. The method includes the steps of pre-characterizing a set of at least three T/V points for a given technology library; creating a two-dimensional space in which temperature is plotted against supply voltage; and interpolating a custom technology library at an arbitrary T/V point within the two-dimensional space. Another aspect of the disclosure includes using a planar interpolation method. A further aspect includes using a linear interpolation method. Yet another aspect of the disclosure includes using four or more pre-characterized T/V points.

### TECHNICAL FIELD

This invention is related in general to integrated circuit library design, and more particularly, to a method and system for designing a custom library for an Application-Specific Integrated Circuit.

### BACKGROUND

Application-Specific Integrated Circuits (ASIC) are built with a set of circuit specifications written in a standard hardware description language such as Verilog. A designer “synthesizes” the design from Verilog to an integrated circuit, verifies the circuit behavior, creates a circuit layout, and then creates a mask from the layout to produce an ASIC. U.S. Pat. No. 5,933,356 to Rostoker, et al describes ASICs in detail, which is hereby incorporated in reference.

It is generally known that a cell library is a key part of ASIC design. For some types of ASICs such as a programmable ASIC, a supplier provides a designer with a library of logic cells in the form of a design kit, and the designer normally does not have a choice in the library or its contents, and the cost is usually a few thousand dollars. For other types such as Masked Gate Arrays (MGA) and Cell-based ASICs (known as CBICs) a designer generally has three choices: (1) an ASIC vendor may supply a cell library, (2) the designer may buy a cell library from a third party library vendor, or (3) the designer may build his own cell library. The first choice, using an ASIC-vendor library, requires the designer to use design tools approved by the ASIC vendor to enter and simulate a design. This ASIC vendor library is usually a phantom library, i.e., the cells are empty boxes or phantoms, but contain enough information for layout, for example, one would only see the bounding box or abutment box in a phantom version of the cell. After a designer completes a layout, he hands off a netlist to an ASIC vendor who fills in the empty boxes (phantom instantiation) before manufacturing a chip. The second and third choices require a buy-or-build decision.

Each cell in an ASIC cell library generally includes a physical layout; a behavioral model; a Verilog/VHDL model; a detailed timing model; a test strategy; a circuit schematic; a cell icon; a wire-load model; and a routing model. For MGA and CBIC cell libraries one needs to complete cell design and cell layout if it is hidden inside a phantom, but eventually, a layout is needed. In a programmable ASIC, cell layout is part of the programmable ASIC design.

An ASIC designer needs a high-level behavioral model for each cell because simulation at the detailed timing level takes too long for a complete ASIC design. For a NAND gate, in general, a behavioral model is simple. But a multiport RAM model can be complex. A designer may require Verilog and VHDL models in addition to the models for a particular logic simulator. ASIC designers also need a detailed timing model for each cell to determine the performance of the critical pieces of an ASIC. Typically, it is too difficult, too time consuming, and too expensive to build every cell in silicon and measure the cell delays. Therefore, library engineers simulate the delay of each cell, a process known as characterization.

Characterizing a standard cell or gate array library includes circuit extraction from the full custom cell layout for each cell. The extracted schematic has parasitic resistance and capacitance elements. Library engineers or developers then simulate each cell including parasitic elements to determine switching delays. Simulation models for transistors are derived from measurements on special chips included on a wafer called process control monitors (PCMs) or drop-ins. Developers then use the results of circuit simulation to generate detailed timing models for logic simulation.

Cell schematic—a netlist description—describes each cell so that the cell designer can perform simulation for complex cells. One need not have the detailed cell schematic for all cells, but enough information is needed to compare what is intended to be on the silicon (the schematic) with what is actually on the silicon (the layout)—this is a layout versus schematic (LVS) check.

Today's computer-aided design (CAD) systems include software tools to design electronic circuits, referred to as Electronic Computer Aided Design (ECAD) systems. Usually an ECAD system performs different functions: a schematic editor, a logic compiler, a logic simulator, a logic verifier, and a layout program.

The schematic editor allows a user to enter and/or modify a schematic diagram via a display screen and generates a netlist, which is a summary of connections between components. The logic compiler takes the netlist as an input, and using a component database, outputs information necessary for layout, verification and simulation into one or more schematic object files with a format optimized specifically for those functions. The logic verifier checks the schematic for design errors, such as multiple outputs connected together, overloaded signal paths, and the like, and generates error indications if any such design problems exist. The logic simulator takes the schematic object files and simulation models, and generates a set of simulation results, based on instructions, initial conditions and input signal values provided to it either in the form of a file or user input. The layout program generates data from which a semiconductor chip (or a circuit board) may be laid out and produced.

Thus, in general, ASICs use predefined and pre-characterized cells from a library of existing circuits such as standard cells, embedded memories and I/O cells. U.S. Pat. No. 5,402,358 provides some background information on such cell libraries. These libraries determine characteristics such as tiring accuracy, power modeling, power optimization, noise control and density of the resulting silicon. U.S. Pat. No. 6,189,131 provides some additional information on technology libraries used in ASIC design.

Optimizing ASIC circuit synthesis using timing characteristics of cells is time consuming and requires simulating each timing arc and characterizing it using complex software. Within a technology library, a timing arc is modeled as a point in a lookup table and depends on input slew and output load variations for a given cell. Producing such a library, which requires SPICE-level simulation for each timing arc, is computationally complex and time consuming.

Usually, elements of technology libraries are designed to cover a spread of both manufacturing and ultimate circuit environment conditions that are said to represent the best and the worst case processing conditions over which a circuit must be designed to operate correctly. For example, a technology with a nominal, or target supply voltage (Vdd) of 1.0V that allows for a variation of +/−10% (+/−0.1V) and an allowed temperature (T) range of 40° C. to 125° C. would typically have best/worst case operating specified as:

(T=−40° C.; Vdd=1.1 V; best case process, i.e. fastest circuit operation)

(T=+125° C.; Vdd=0.9V; worst case process, i.e. slowest circuit operation)

Thus, an operating condition (T/V condition) includes an operating temperature and a supply voltage for a given process. In general, the worst-case process represents a combination of manufacturing and T/V conditions that would result in the slowest circuit operation. The best case, of course, represents conditions that would result in the fastest circuit operation.

A circuit designed with a particular technology library designed for a set of extreme T/V conditions operates within the selected two extreme T/V conditions. For a given technology, therefore, library vendors usually provide only the worst-case and the best-case tiring libraries. Often, circuit designers need to design to conditions not represented by the worst and the best-case library files. For a library vendor, producing libraries at arbitrary T/V points for each customer could be costly. Accordingly, there is a need for an improvement in the art whether for a library vendor or for a designer developing an in-house library.

### SUMMARY

In this application, the word “library” without qualification means a technology library. In an aspect, this disclosure is directed toward a method of generating a technology library at a non-standard T/V point. The method includes the steps of pre-characterizing a set of at least three T/V points for a given technology library; creating a two-dimensional space in which temperature is plotted against supply voltage; and interpolating a custom technology library at an arbitrary T/V point within the two-dimensional space. Another aspect of the disclosure includes using a planar interpolation method. A further aspect includes using a linear interpolation method. Yet another aspect of the disclosure includes using four or more pre-characterized T/V points.

### BRIEF DESCRIPTION OF THE DRAWINGS

These and other features, objects and advantages may be more readily understood from the following detailed description and the accompanying drawings, in which:

FIG. 1 illustrates the functions of a library compiler;

FIG. 2 illustrates a technology library for an Application-Specific Integrated Circuit (ASIC);

FIG. 3 illustrates syntax used in designing a library;

FIG. 4 illustrates a method of generating a compiled technology library; and

FIG. 5 illustrates a flow chart of an embodiment of the disclosed method.

### DETAILED DESCRIPTION

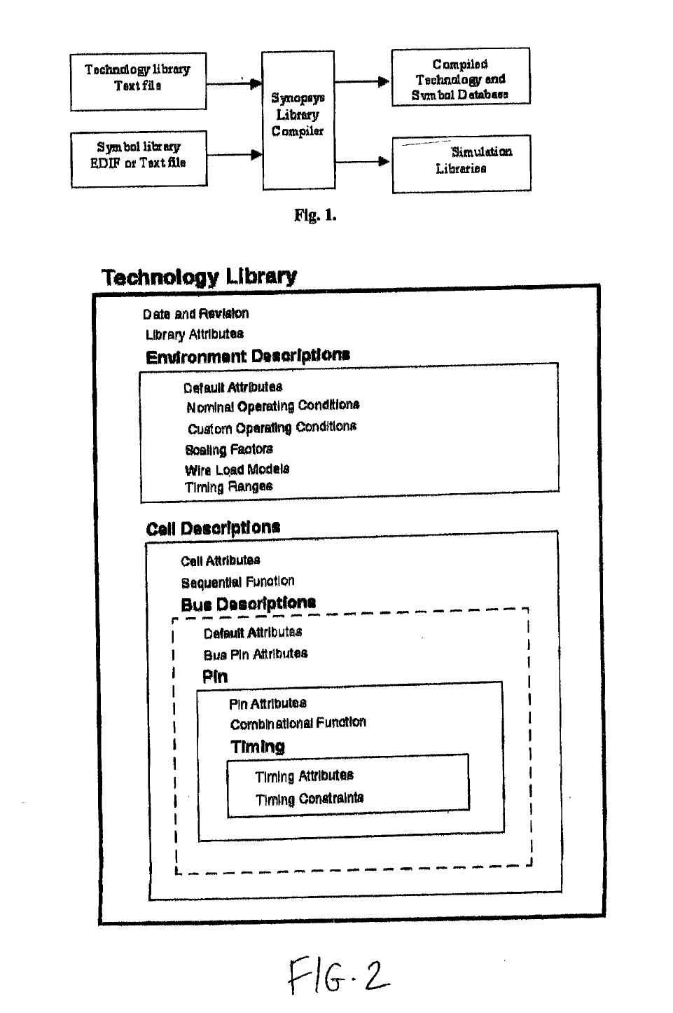

FIG. 1 illustrates how a library compiler operates. An ASIC Cell library is a text file describing component circuits used to build an ASIC, which file is compiled into a “.db” format or a Verilog format by the Library Compiler using a command-line or a graphical user interface. The latter of these formats sometimes supports simulation, synthesis, test and entry of data.

A library compiler generates synthesis libraries (which hold technical characteristics and schematic symbols and are used to support synthesis tools such as those marketed by Synopsys); technology libraries (which contain area, timing, function and other characteristic information for each component in the ASIC library); schematic libraries (which hold information on schematic symbols for each component, useful for a design analyzer program to generate circuit schematics); and Verilog simulation ASIC libraries (which hold timing and functional information useful when simulating performance). The symbol libraries can be created by transferring information from CAD systems in the EDIF format, while the technology libraries can be described in text format.

FIG. 2 illustrates a technology library. A technology library contains four types of information. These four types are, (a) Structural information, which describes connectivity between cells, bus and pin descriptions and interface to the outside world; (b) Functional information, which describes logical functions of every output pin of every cell for the design compiler program to use and map the logic of a design to the actual ASIC technology; (c) Timing information, which describes parameters for pin-pin timing relations, delay calculation and ensures accurate timing analysis and optimization; and (d) Environment Information, which describes the manufacturing process, operating temperature, supply voltage variations and design layout. This information includes interconnect-wire areas, wire capacitance and resistance and scaling factors for process, temperature and voltage variations. Library development involves (a) describing a library, which includes creating a library, defining cells and application-specific data; (b) compiling a library; and (c) optimizing the library with a design compiler.

Typical steps performed in creating a library include determining the technology, which could be CMOS or FPGA; selecting a delay model; describing a library; and naming. As stated above, part of defining a library includes the operating environment as well. This includes (a) describing the environment—i.e., modeling delay calculation scaling factors; defining default attributes; modeling operating conditions and wire load. Persons of ordinary skill know how to do these things and a repetition of those details is unnecessary.

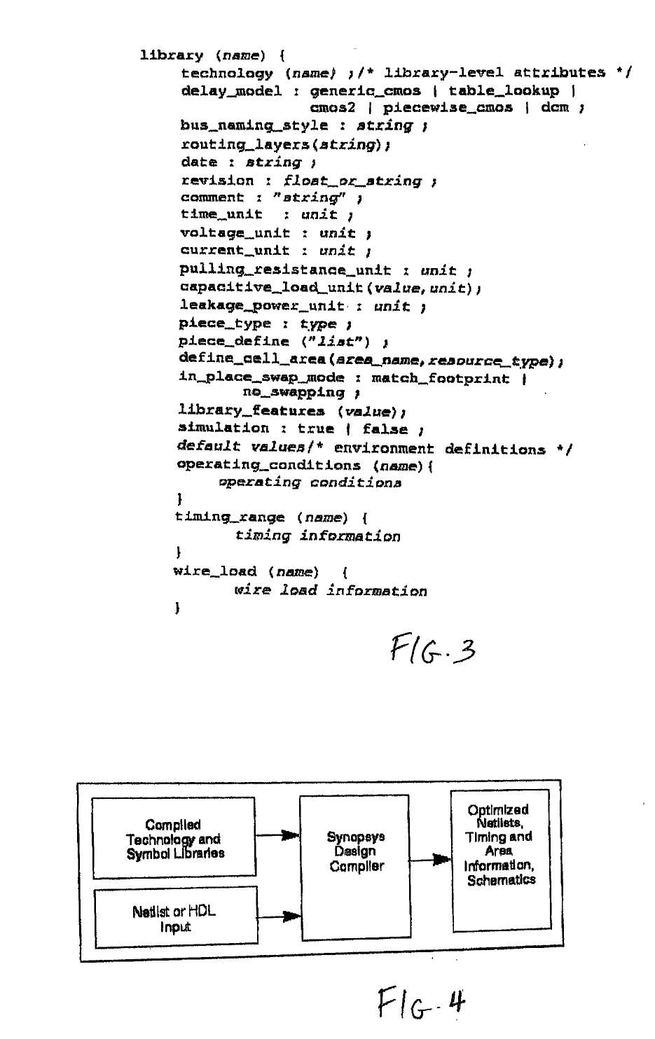

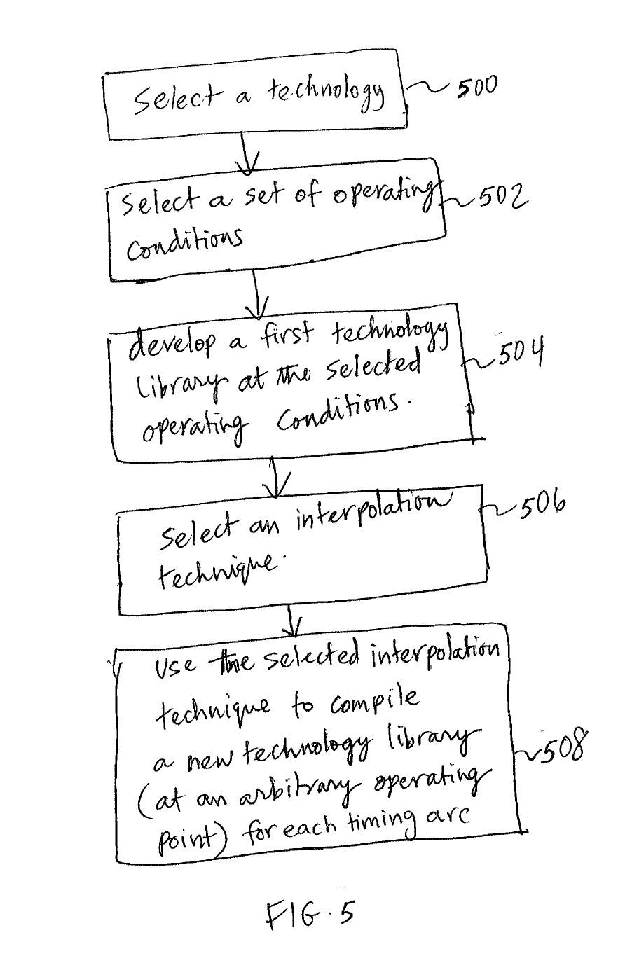

FIG. 3 illustrates the syntax of a library definition. Using such syntax, one can set operating conditions for testing in simulated environments, for example, as follows.

library (test){

operating_conditions (worst_case_conditions){

process : 1.5;
temperature: 70;
voltage : 4.75;
tree_type : worst_case_tree; // environment interconnect model

}

. . . }

### Compiling and Managing a Library

After a technology library is defined as shown above, a library developer compiles the library using either a command line interface or a graphical interface. Compilation involves two steps: the compiler program reads the library source file into memory and then executes the compiler logic to determine syntax correctness and semantic consistency and outputs a library memory file in either a Synopsys format (“.db” format) or in Verilog format. After compiling a technology or a symbol library, a designer may use a design compiler program to generate designs and schematics. As an example, the following code illustrates a technology library definition of a D Flip-Flop.

D Flip-Flop illustrating table-based timing

cell(“Dflipflop”) {

area : “25”;
pin(D) {

direction : input;
capacitance : 0.002;
timing( ) {

timing_type : setup_rising;
related_pin : “CK”;
fall_constraint (template_ss3x3) {

index_1( “0.0153, 0.2619, 0.5091” );
index_2( “0.0072, 0.2578, 0.5052” );
values ( \

“0.2286, 0.1601, 0.1477”, \
“0.3585, 0.2892, 0.2678”, \
“0.5979, 0.5346, 0.5092” );

}
rise_constraint (template_ss4x4) {

index_1( “0.0059, 0.2566, 0.4060, 0.5002” );
index_2( “0.0073, 0.2571, 0.4046, 0.5012” );
values ( \

“0.1082, 0.0872, 0.1127”, \
“0.1537, 0.1228, 0.1403”, \
“0.1506, 0.1358, 0.1680” );

}

}

timing( ) {
timing_type : hold_rising;
relate_pin : “CK”;
rise_constraint (template_ss3x3) {

index_1( “0.0073, 0.2571, 0.5069” );
index_2( “0.0076, 0.2579, 0.5056” );
values ( \

“−0.0929, −0.0741, −0.0948”, \
“−0.1351, −0.1061, −0.1272”, \
“−0.1102, −0.0828, −0.0910” );

}
fall_constraint (template_ss3x3) {

index_1( “0.0110, 0.2586, 0.5076” );
index_2( “0.0069, 0.2575, 0.5060” );
values ( \

“−0.1410, −0.0587, −0.0410”, \
“−0.2764, −0.2017, −0.1773”, \
“−0.5130, −0.4336, −0.4187” );

}

}

}
pin (CK) {

clock : true;
min_pulse_width_high : 0.6;
min_pulse width_low : 0.7;
direction : input;
capacitance : 0.002;

}
pin(Q) {

direction : output;
function : “IQ”;
timing( ) {

related_pin : “CK”;
timing_sense : non_unate;
timing_type : rising_edge;
cell_fall (template_sc4x4) {

index_1( “0.0072, 0.0277, 0.3368, 0.5199” );
index_2( “0.0000, 0.0103, 0.0383, 0.2001” );
values, ( \

“0.1938, 0.2718, 0.4107, 1.0838”, \
“0.2075, 0.2855, 0.4245, 1.0975”, \
“0.2969, 0.3770, 0.5173, 1.1907”, \
“0.2968, 0.3778, 0.5192, 1.1928” );

}
cell_rise (template_sc4x2) {

index_1( “0.0073, 0.0453, 0.2643, 0.4228” );
index_2( “0.0000, 0.0956” );
values ( \

“0.2745, 1.0592”, \
“0.2820, 1.0663”, \
“0.3361, 1.1205”, \
“0.3903, 1.1746” );

}
fall_transition (template_sc3x4) {

index_1( “0.0072, 0.3199, 0.5021” );
index_2( “0.0000, 0.0103, 0.0694, 0.2001” );
values ( \

“0.0267, 0.0714, 0.2720, 0.7485”, \
“0.0302, 0.0737, 0.2723, 0.7485”, \
“0.0302, 0.0748, 0.2726, 0.7486” );

}
rise_transition (template_sc3x3) {

index_1( “0.0073, 0.0279, 0.7500” );
index_2( “0.0000, 0.0084, 0.0965” );
values ( \

“0.0260, 0.0851, 0.7459”, \
“0.0262, 0.0852, 0.7461”, \
“0.0260, 0.0855, 0.7465” );

}

}

}

}

After a compiled technology library is generated, a designer can manage the library, i.e., he can add/remove new components and/or conditions to/from the library—such as new cells, operating conditions, timing range, scaling factors, bus-type definitions, and interconnect wire load. Additionally, the designer may be able to compare a symbol library with a technology library for consistency.

### Designing a Custom Library

Having thus described the method of creating and managing a technology library, the present disclosure enhances the state of the art by using a mathematical interpolation technique to generate a new library for a given set of operating conditions. These operating conditions could be a combination of T/V conditions. For a given timing arc, which is modeled in a library, one can have parameter values at three different combinations of T/V conditions. One can obtain these parameter values from three source libraries, i.e., the original released library and two auxiliary interpolation libraries. The released library can be a library purchased from a vendor.

These parameter values, which represent a specific piece of timing information that a designer would need, mathematically define a plane in a two-dimensional space, which may be called the “T/V space”. Thus, one can obtain information about a timing arc at three T/V points. These three points enable interpolation to obtain a technology library at the T/V point of interest. In sum, one could find a point on the T/V plane. To produce a new library at the desired additional T/V point, one could simply repeat this exercise over all of the table entries for a given timing arc, and then over all of the timing arcs that are defined in the library. A designer selects how many interpolation libraries—and the T/V conditions they represent—would be adequate to achieve a desired relief based on a trade-off between accuracy and the cost, timeliness or other criteria. As stated above, one of these points is pre-determined; it is generally the released library point, which represents the slow process conditions, for example, 0.9V/125° C. point. We assume that the valid T/V ranges are −40° C. to 125° C. for temperature and 0.9V to 1.1V for the supply voltage as stated earlier.

To produce a more accurate and complete solution, one could characterize as many additional libraries as required or possible, for example, three additional representing four corners of the valid T/V region, i.e., 0.9V/125° C. (default), 0.9V/−40° C., 1.1V/125° C., 1.1V/−40° C. If one selected such a design and arrived at a four-point interpolation instead of a three-point interpolation as discussed above, one could give the designers the ability to generate libraries over the complete range of allowed T/V conditions. But a problem with this approach could be that it requires an additional library (for example, four rather than three), and the interpolation error in the resulting library could be larger as the size of the box gets bigger.

To avoid such issues, a library developer may balance opposing criteria. This may include a balance between the number of extra libraries to be produced and any error that may be introduced as a result of selecting a fewer number of libraries. In order to limit the number of extra libraries and any error, one could just use a three-point interpolation technique instead of a four-point interpolation method and then tighten up—i.e., narrow down—the ranges over which interpolation libraries may be produced. This likely satisfies designers who prefer some relief in slow process conditions in order to make a chip work at a desired speed.

In the example provided, the slow conditions were at 0.9V and 125° C. A designer still has to grapple with the fast library, for example, at 1.1V/−40° C., that defines operating conditions at the opposite T/V extreme. With that case already “covered”, it is not usually necessary to provide slow libraries near the “fast” T/V conditions. Thus, allowing a designer to obtain a new slow library with a new supply voltage as high as 1.0V (a nominal value) or a temperature as low as 85° C., for example, might allow a desired relief to meet design specifications. Accordingly, two additional libraries with less V and T variation can be chosen. Given that the interpolation ranges of voltage and temperature are chosen to be 0.9V to 1.0V and 85° C. to 125° C., there are four possible combinations: 0.9V/125° C., 0.9V/85° C., 1.0V/125° C., and 1.0V/85° C. One point, for example, the worst-case scenario, is pre-determined: 0.9V/125° C. The library developer can select two of the remaining three points depending on the number of libraries needed and other criteria as described above. Because a designer desires relief from the conditions at the 0.9V/125° C. point, the developer advantageously selects two points closest to this, i.e. 0.9V/85° C. and 1.0V/125° C. These points are found to provide desired relief when a designer seeks only to modify one of the two conditions—T or V—while the other condition remained constant. Of course, this modification of conditions may impose other limitations such as, for example, the voltage may not be varied more than 1.0V or the temperature may not be lowered below +85° C. for a particular case. Another way to achieve a desired relief may be to increase the upper voltage limit to, say, 1.1V. This makes the triangle larger and therefore provides a broader range of T values over which interpolation could occur for voltages below 1.1V, even though a designer would never probably use the 1.1V condition in a slow library. These examples provide the kind of trade-offs that a developer could weigh in while performing interpolation.

### Interpolation Technique to Develop a Technology Library

FIG. 5 illustrates the method of devising a new technology library with a selected or a desired set of operating conditions such as temperature and voltage. As in the case of any library, first, a designer selects a technology—FPGA, CMOS or other similar technology (step 500). Then the designer suitably selects a set of selected conditions at which the desired technology library would be designed (step 502). In order to generate a technology library at a selected or desired set of operating conditions, the designer advantageously starts with a technology library with a known set of operating conditions (step 504).

The technique for generating library representing a new T/V combination from a pre-existing set of libraries at different T/V combinations uses a mathematical approach called interpolation. As there are numerous methods of interpolation techniques, the designer then selects a particular method, for example, bilinear interpolation technique (step 506). Bilinear interpolation may be implemented in two dimensions—for example, in the instant case, dimensions T and V—as taught in the book, William H. Press, et al., Numerical Recipes in C: The Art of Scientific Computing, (2d ed., Cambridge Univ. Press), which is incorporated by reference herein. The example provided in this book teaches a two-dimensional interpolation method in which interpolation points are located on a rectangular grid.

The instant disclosure contemplates a total of four interpolation libraries. Persons of ordinary skill in the art would be able to derive modifications of this to apply to cases of three or more of sets of interpolation libraries with arbitrary distributions in V/T space. The case of interpolation in only one dimension, i.e., either T or V, is simply a degenerate implementation of these techniques that would require a minimum of only two libraries representing the appropriate variation in the selected dimension.

To produce a new library, the interpolation algorithm may be invoked for each timing arc in the known technology library (step 508). Because data for each timing arc are generally specified in tables that represent for example, slew and load variation for that arc, one must “solve”the tables in each interpolation library for a set of slew/load values that will constitute the indices for the table in the new interpolated library. The result is a set of values, each of which represents the value of a tiring arc not only for a given set of slew/load conditions, but also for the various T/V points. Then a designer or a developer applies a selected T/V interpolation technique to these values. The result of the interpolation will yield a timing arc value for the selected slew/load condition, but at a new, desired, T/V point.

To complete the new library, the designer applies this interpolation procedure to each slew/load index point for a given timing arc, and then repeats the entire procedure for each timing arc. Note that individual tables in the known libraries may have dependencies other than slew/load example used here. Slew/slew is also common, as is a one-dimensional dependence upon either slew or load. Simple scalar values are also common. This technique is, of course, not dependent upon such variations applying equally well to all of these cases as well as the case where the internal tables have three or more dimensions to them.

Thus, a feature of the disclosed method is to generate a customized library from existing libraries via interpolation. Doing so might provide some relief to a designer from the needlessly stringent voltage or temperature conditions that a standard or commercially available library may present. In another aspect, the disclosed method uses interpolation techniques by taking three or more T/V points in a plane that bounds the desired T/V point and generates a library that satisfies the T/V conditions at that point and then use interpolation techniques to design a library that could operate at the desired point. Persons of ordinary skill in the art will easily recognize and appreciate that the number of points (i.e., 3 or 4) and the mechanism for selecting them are only provided for purposes of illustration and not to limit the scope of the disclosed method.

The method could be useful for a library vendor or for a designer who builds his custom libraries in-house, if that designer needs to produce libraries at an arbitrary V/T condition. As stated above, a library is designed to operate over a pre-determined set of environmental conditions. In particular, supply voltage (V) and temperature (T) ranges are defined. To be specific, let's use some numbers and say that the valid (supply) voltage range is 1.0+/−0.1V, and the temperature range is from −40° C. to 125° C. The library vendor generally provides two libraries, one representing the slowest possible operation and the fastest.

The “slow” library is a result of a set of environmental conditions such that the slowest circuit operation would result. This translates into a set of HSPICE simulation conditions representing this slow operation, which is obtained from the conditions in the manufacturing process resulting in the slow operation, and from the lowest allowed voltage and the highest allowed temperature, in this case 0.9V and 125° C. The “fast” library is the reverse situation, with fast manufacturing process conditions and highest/lowest supply and temperature values (i.e., 1.1V and −40° C.).

As one might expect, it is the slow library that limits the highest speed at which a circuit can operate. Therefore, engineers generally design their circuits to meet specifications of the slow library. They then check it for so-called “race conditions” with the fast library (i.e., if certain parts of the circuit speed up too quickly relative to others, the circuit may fail).

If the circuit works at both sets of conditions, it is assumed that it will work in between these two sets of conditions as well. Because the slow T/V conditions limit the speed of the resulting circuit, this is the point on which a designer would focus. It is sometimes the case that a given circuit design is not required to operate at the T/V conditions which are represented in the slow library. For those designers, the slow library is too constraining. For example, the highest temperature expected on a given chip might only be 100° C., or the lowest voltage might only be 0.95V, and relief from the stringent slow library conditions may be desirable.

In such cases, the vendor-supplied library may unnecessarily limit performance of circuit designs. Designers would like to see a slow library with T/V conditions representing their actual design conditions. Creating libraries for all of the possible conditions, which designers might like to see, can quickly become prohibitively expensive for the library vendor, as the production of these libraries takes considerable time and computer resources. Our solution does involve the creation of extra libraries, but the number of these is known (2) ahead of time and can be scheduled. They also do not hold up the initial release of the library, as they can be created later (the designers could start work with standard library files and proceed to a library with the desired T/V point when that point becomes available). Selection of additional interpolation libraries can be by experience and engineering judgment or heuristics, and may depend on a trade-off between providing as wide a useful range in T/V variation as possible vis-à-vis ensuring that the interpolation does not introduce excessive error.

When a designer interpolates with a slow library, T/V conditions can be chosen near original library values. This is because the designer would like to obtain a small amount of relief from the stringent worst-case conditions. Thus, a reasonable T/V range for slow interpolation might be something like 0.9 to 1.0V and 85° C. to 125° C. This would imply 3 interpolation libraries: 0.9V/125° C. (the release library), 1.0V/125° C., and 0.9V/85° C. It should be noted that this did not include a selection of the T/V conditions of 1.0V/125° C. The reason for this is that if one were to limit oneself to two extra libraries and obtain relief in one dimension (i.e., worst case conditions) while maintaining the broadest possible range to cover more design cases.

It should, however, be noted that the disclosed method is aimed at using interpolation to provide faster library turnaround for customers and/or predictability in library development for the vendor. Further, there is nothing special about the triangular (i.e., three-point) interpolation technique described here. One could alternatively perform a four-point interpolation, or interpolation with more than four points. Thus, one could cover a more elaborate range of T/V conditions if more accuracy is desired. It should be noted that there is a trade-off to be made by the vendor.

In an embodiment, three points are chosen because that is a minimum number required to allow variation in two dimensions (V and T). Note also, that interpolation could also be used for the fast library, as well. As a practical matter, this probably would not be needed since it is the slow library that limits the speed, but this could be done. Of course, additional interpolated libraries should be designed so as not to slow down an initial library release; they could be made available later. The three-point interpolation of the slow library is provided as an example of a useful feature of this invention, but the invention should not be limited to this case.

The foregoing describes the method of creating a custom technology library by interpolation and thereby achieving fast turnaround and predictable vendor schedules. Persons of ordinary skill in the art may modify the disclosed method without departing from the principles disclosed herein or without undue experimentation. For example, other known interpolation methods than bilinear interpolation may be used; and additionally, instead of interpolation, extrapolation or other statistical methods may be used to design a desired technology library. All such modifications and departures are within the scope of the appended claims.

What is claimed is:

1. A method of creating a technology library comprising the steps of:
developing a first technology library at a predetermined operating condition; and
using an interpolation technique to develop a second technology library that satisfies a desired operating condition.

2. The method as in claim 1 further comprising the step of selecting a technology.

3. The method as in claim 2 wherein the technology is CMOS or FPGA.

4. The method as in claim 1 wherein the operating condition is a set of temperature/voltage (T/V) condition.

5. The method as in claim 1 wherein the first technology library is the worst-case technology library for the given T/V condition.

6. The method as in claim 1 wherein the interpolation technique is a planar interpolation.

7. The method as in claim 1 wherein the interpolation technique is bilinear interpolation.

8. The method as in claim 1 wherein the interpolation technique is applied to each timing arc in the first technology library.

9. The method as in claim 1 further comprising the step of using one or more precompiled technology libraries within a preselected range of operating conditions.

10. The method as in claim 9 wherein the one or more precompiled technology libraries are selected at points that surround in space a desired operating condition at which a new library is created.

11. A method of creating a custom ASIC library comprising the steps of:
precompiling two or more technology libraries each of which is configured to enable a given technology to operate at a predetermined set of operating conditions;
selecting a set of operating conditions such that an ASIC produced at the arbitrary set of operating conditions satisfies the needs of a given design;
applying an interpolation technique to each timing arc in each of the precompiled technology library, thereby creating a library at the selected operating conditions.

12. The method as in claim 11 wherein the interpolation technique is bilinear interpolation.

13. The method as in claim 11 wherein the selected set of operating conditions includes an operating temperature or an operating voltage or both.
